(19) United States
(12) Patent Application Publication
(10) Pub. No.: US 2015/0100433 A1
(43) Pub. Date: Apr. 9, 2015

(54) Online Reservation System For Local Pickup Of Products Across Multiple Retailers

(71) Applicant: Retailigence Corporation, Redwood City, CA (US)

(72) Inventors: Gene Choy, Los Altos, CA (US); Simon S. Lam, Agoura Hills, CA (US); Peter Christianson, San Francisco, CA (US); Kurt Hayes, Sunnyvale, CA (US)

(73) Assignee: Retailigence Corporation, Redwood City, CA (US)

(21) Appl. No.: 14/046,661

(22) Filed: Oct. 4, 2013

(51) Int. Cl. G06Q 30/06; G06Q 30/02

(52) U.S. Cl. CPC G06Q 30/0635; G06Q 30/0269
USPC 705/14.69; 705/26.81

(57) ABSTRACT

Systems and related methods are disclosed that provide an electronic commerce and communication system that includes real-time product inventory information to enable a customer-driven experience for reservation of products. An electronic commerce exchange is provided that permits customers to browse, search, and reserve products for in-store pickup across multiple merchants, each potentially with multiple retail locations. The exchange includes a real-time product inventory database that maintains real-time product inventory information for the retail locations of the merchants. The product inventory database includes ingest engines that permit an interface to different inventory transfer protocols so that product inventory information can be maintained across disparate inventory systems maintained by different merchants.

### BACKGROUND OF THE INVENTION

Embodiments in accordance with the present disclosure relate to computer networks, and more particularly to commerce over computer networks.

Electronic commerce that is conducted over computer networks such as the Internet continues to increase in its popularity with both merchants and consumers. Today, many merchants offer physical goods such as books, groceries, electronics and compact discs for purchase and delivery using an electronic commerce site or application of the merchant. Many merchants also offer electronic content such as electronic books, music, website access for purchase using an electronic commerce site.

Electronic commerce, sometimes referred to as e-commerce, includes virtual solutions as well as hybrid virtual/physical solutions that are centered around traditional physical establishments (so called brick and mortar stores). Virtual solutions are typically provided by enterprises that have an e-commerce application and/or website but no physical retail location where customers may view and purchase products for immediate consumption. Customers utilize a website or application to browse, search and purchase products. The products are then delivered to the customer using well-known postal or courier solutions.

Hybrid solutions are typically provided by enterprises that have physical retail locations as well as an e-commerce website or application. Typically, a customer may visit a retail location to view and purchase products for immediate possession of the products, or use the retailer's e-commerce site to view and purchase products for delivery.

More recently, enterprises employing virtual solutions have provided customers the option to pick up products from a designated location. For example, a customer may purchase a product on the enterprise's e-commerce site and pick up the product from a warehouse operated by the enterprise. Similarly, some enterprises offering hybrid solutions provide customers with the option to purchase products on an e-commerce site and then pick up the products from a retail location operated by the enterprise. Conversely, these enterprises may also allow customers at a retail location to use the enterprise's e-commerce site to further research or order additional products from the enterprise.

While virtual and hybrid electronic commerce solutions exist, a disconnect remains between services provided by e-commerce sites and those by more traditional brick and mortar establishments. While some retailers provide an e-commerce site to permit purchasing of products for pick up at a retail location, many barriers and obstacles exist.

### BRIEF DESCRIPTION OF THE DRAWINGS

FIG. 1 is a flowchart that describes processing by a reservation system in accordance with one embodiment.

FIGS. 2A-2H are block diagrams depicting a set of messages and user interfaces provided by the reservation system in accordance with one embodiment.

FIG. 3 is a block diagram of a computer network including a reservation system in accordance with one embodiment.

FIG. 4 is a timing diagram depicting communication between the components of FIG. 3 in one embodiment.

FIG. 5 is a flowchart that describes processing by a reservation system in accordance with one embodiment.

FIG. 6 is a flowchart that describes processing of a virtual cart in accordance with one embodiment.

FIG. 7 is a block diagram describing processing of a virtual cart in accordance with one embodiment.

FIG. 8 is a simplified block diagram of a computing device that can be used to implement various embodiments of the disclosed technology.

### DETAILED DESCRIPTION

Systems and related methods are disclosed that provide an electronic commerce and communication system that includes real-time product inventory information to enable a customer-driven experience for reservation of products. An electronic commerce exchange is provided that permits customers to browse, search, and reserve products for in-store pickup across multiple merchants, each potentially with multiple retail locations. The exchange includes a real-time product inventory database that maintains real-time product inventory information for the retail locations of the merchants. The product inventory database includes ingest engines that permit an interface to different inventory transfer protocols so that product inventory information can be maintained across disparate inventory systems maintained by different merchants.

The electronic commerce exchange system is customer centric. Detailed filtering based on customer profile information is provided during reservation processes in one example. A customer profile may include customer preferences including a service provider preference, a communication protocol preference, a brand preference, and a payment method preference.

A reservation platform provides a single user-interface that enables a customer to reserve products from different merchants and/or different retail locations for in-store pickup. The reservation platform provides the ability for customers to purchase and/or make in-store reservation for a number N of items from a number M of retail locations during a single shopping session. The reservation notification can be sent to the retail locations according to retailer preferences and will be mediated by the platform. One or more notifications of the reservation from the multiple retail locations can be sent to the customer.

The reservation platform includes a messaging engine or system that implements a centralized bus for communicating with different merchants and different customers using a plurality of communication protocols. The messaging engine communicates with retail locations, customers, and in conjunction with the product inventory database, enables real-time and accurate reservation of products for pickup across the multiple retailers. The messaging engine mediates communication between customer and retail locations. Additionally, the messaging engine provides an interconnecting bus with built-in reservation protocol and process translations to interface with many disparate systems provided by the different merchants.

The reservation platform implements real-time electronic inventory confirmation in response to customer selection of products for pickup. To improve accuracy and customer experience, the messaging engine generates messages for physical inventory verification at retail locations selected for pickup of one or more products. In response to a message, the retail location physically verifies the presence of the selected product and reserves or sets aside the requested item(s) for the specific reservation request. In one embodiment, an employee at the retail location physical verifies the presence of the selected product. This provides a physical inspection break in the electronic chain that enables accuracy and inspection for damage or to fit items for sales. The messaging engine receives messages from the retail locations with confirmation, denial, or modification of the reservation request based on the physical inventory verified in the store. The messaging engine generates one or more messages to the customer with confirmation and reservation pickup information for the selected products at the retail locations. In this manner, physical inventory is verified by a person before the reservation platform confirms a reservation for a product at a retail location.

The request is for physical inventory verification with explicit human intervention is provided in one embodiment. An employee or other agent of the retail location may physically examine existing inventory to determine whether requested items are in-stock and physically present at the retail location. In this manner, anomalies or deficiencies in electronic inventory records can be overcome so that customers do not arrive at a retail location to discover that an item could not be reserved.

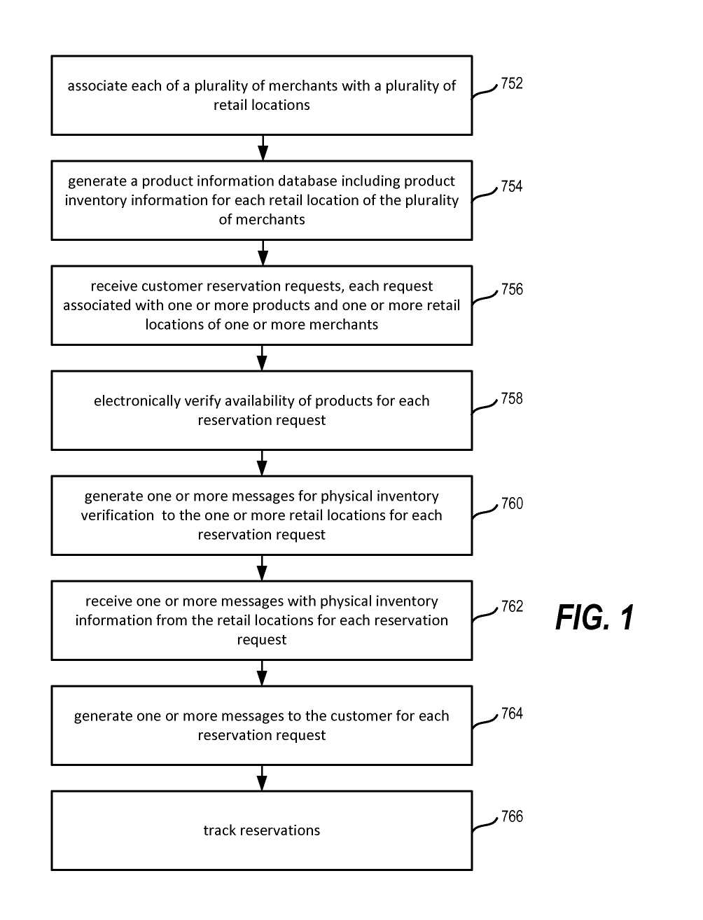

FIG. 1 is flowchart describing processing by a reservation system according to one embodiment. An electronic commerce exchange system associates each of a plurality of merchants with a plurality of retail locations at step 752. Step 752 may also include associating some merchants with a single retail location. The system maintains a database or other form of merchant records including an identification of each retail location of the merchant, an address of the retail location, contact information for the retail location, inventory transfer protocols associated with the retail location, and message transfer protocols associated with the retail location.

At step 754, the system generates a product information database that includes product inventory information for each retail location of the plurality of merchants. The product inventory information is organized by location such that the system maintains product inventory information for individual retail locations. Step 754 may include periodically updating the database to reflect current inventory information. The system includes a centralized inventory information transfer bus that permits inventory information to be received using numerous different inventory information transfer protocols.

At step 756, the system receives customer reservation requests. Each of the requests is associated with one or more products and one or more retail locations. Each request is to reserve products for in-store pickup at a corresponding retail location. A request may include items from more than one retailer. Some items may require payment before reservation, while others may be reserved without payment. Merchant preferences may be used to establish reservation requirements for products from individual retail locations. In one example, the system provides a website or application that enables reservation requests. In other examples, the system provides a virtual cart or other mechanism that permits the receipt of reservation requests through third-party applications and websites, for example.

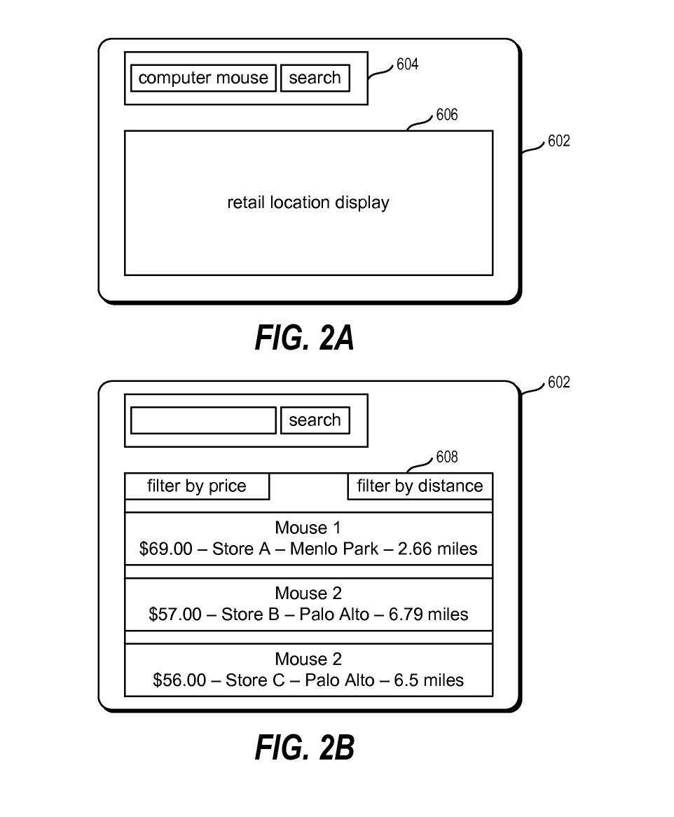

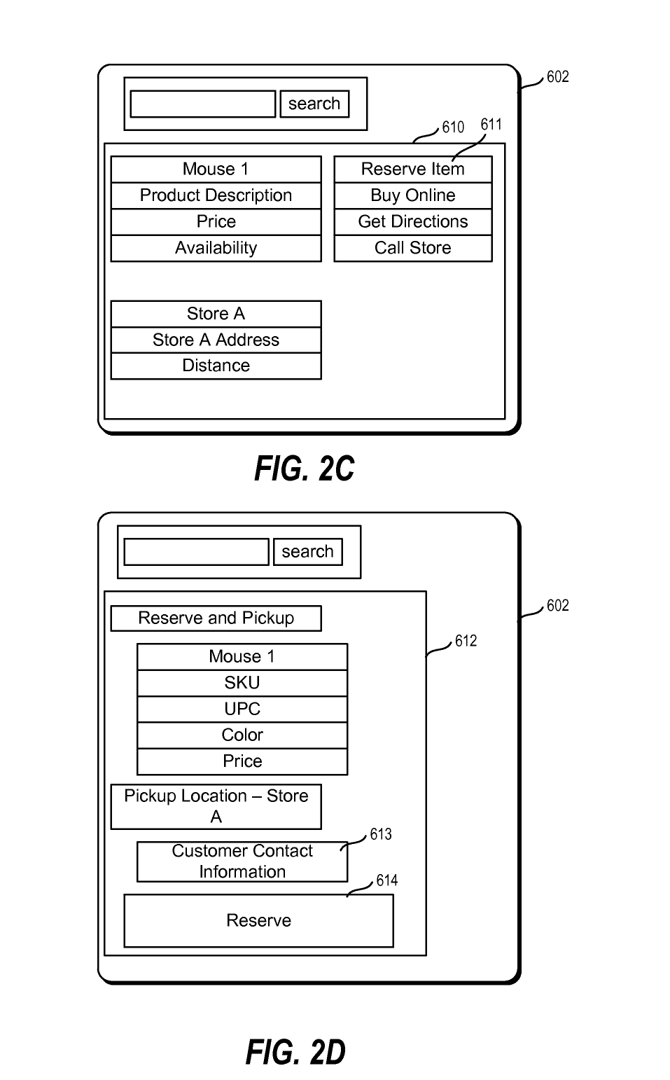

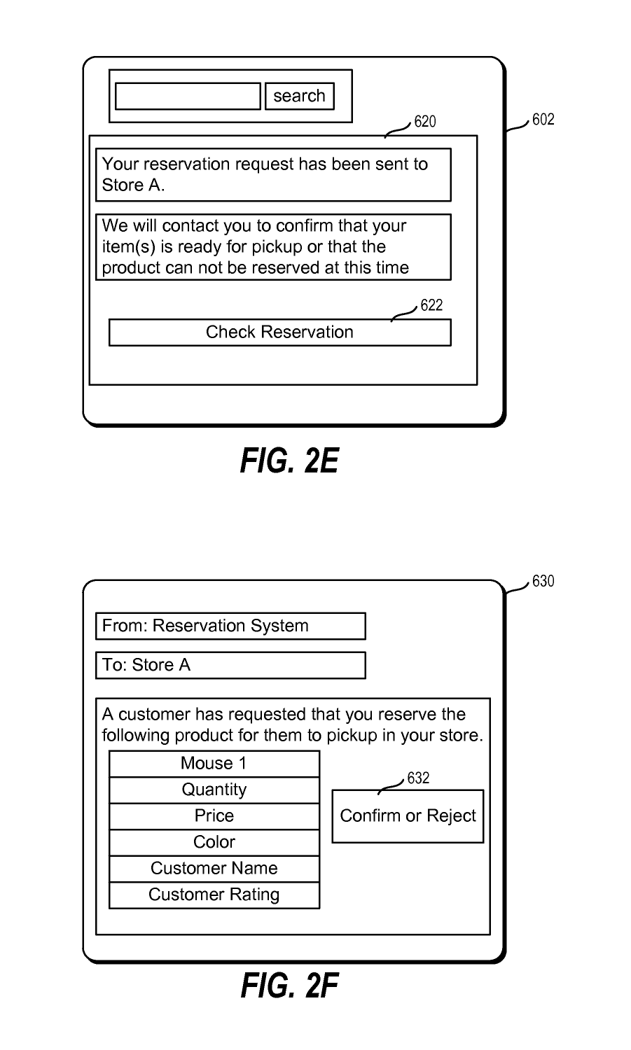

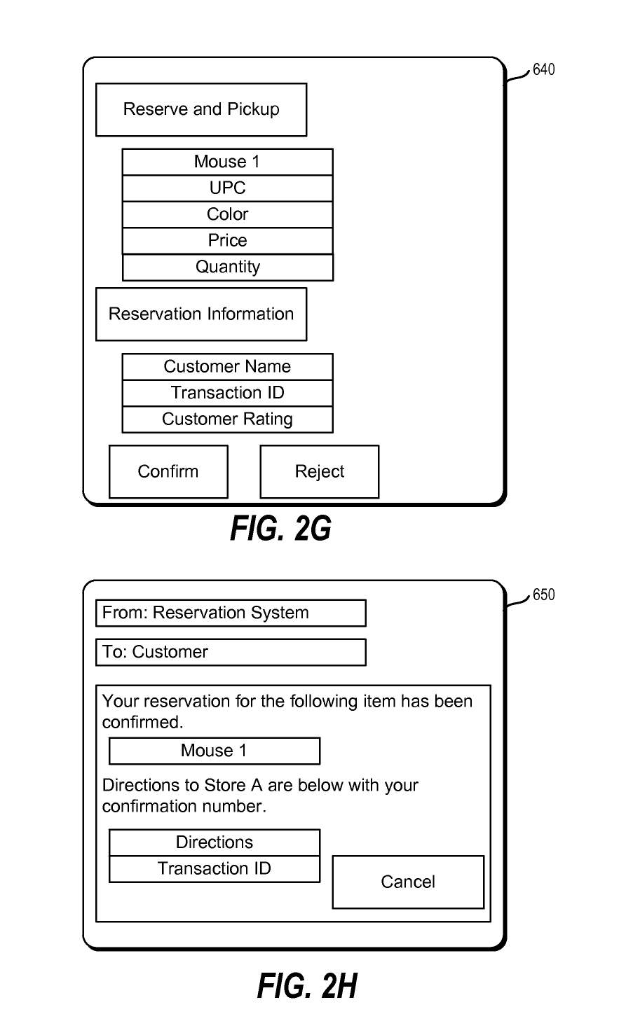

FIG. 2A is a block diagram depicting an example of a customer user interface 602 in accordance with one embodiment. The depictions in FIG. 2A-2H are exemplary only and are intended to conceptually illustrate a user perspective of the disclosed technology. Modifications for numerous implementations will be apparent. Interface 602 may be provided by a website hosted by the exchange system or an application on a client device interfacing with the exchange system. In another example, a third party may provide an interface to the exchange system and generate interface 602. The exchange system may receive reservation requests using an interface 602 at step 756 in one example. In the depicted example, the user interface includes a search field 604, allowing a customer to enter a search query (e.g., “computer mouse”). In this example, the user interface includes a display 606 of nearby retail locations for which the system maintains product inventory information. After entering the search query, the user interface provides search results 608 including a list of available products matching the search query from nearby locations as shown in FIG. 2B. The search results may be filtered using the customer's profile. Each entry in the search results includes a product name, price, store identifier, and distance to the store from the customer's present location.

FIG. 2C depicts user interface 602 with a display 610 generated in response to a selection of a particular entry from the search results in display 608. In FIG. 2C, display 610 includes a product name, product description, price, availability, store identifier, store address, and distance to the store. Additionally, display 610 presents the option to reserve the item for in-store pickup, the option to buy the item online, the option to get directions to the store and the option to call the store. In response to a selection to reserve the item as provided by a customer using button 611, the user interface generates a display 612 including information for reserving the item for pickup of the retail location as shown in FIG. 2D. In this example, display 612 requests customer contact information 613 from the customer. In other examples, a customer may login using previously generated credentials so that customer information does not have to be provided. Cookies or other identification techniques may be used so that the system can recognize a user in subsequent sessions following an initial login. A reserve button 614 is provided to enable the customer to confirm their desire to reserve the item for pickup.

If the user selects the reserve button, a reservation request is received by the system. In response to the reservation request, the system generates a display 620 including an acknowledgement of the reservation request as shown in FIG. 2E. Display 620 includes information regarding the customer's reservation request. The display confirms that the system is verifying the physical availability of the items by a person at the retail location and is setting those items aside for the customer. The display also provides a check reservation button 622 for the customer to check their reservation. The button may include a URL to an application or website provided by the system that provides reservation status information.

It is noted that reservation requests may be received in numerous different ways and that the interfaces depicted in FIGS. 2A-2H are exemplary only. For example, a reservation request may be received from a server serving a banner advertisement or display advertisement or other type of product placement or product sponsor message. In such instances, interaction with the reservation platform may begin in response to the customer selecting or providing input in response to the advertisement or product message. Although FIGS. 2A-2H depict the reservation of a single product from a single retail location, the system provides a user interface that is configured to receive reservation request from a plurality of customers for the reservation of any number (N) products across any number (M) of retail locations.

Returning to FIG. 1, the system electronically verifies the availability of the products from the selected retail locations for each reservation request at step 758. The product inventory database may be used to present items in response to search or other requests as earlier shown. At step 758, the product inventory database or another mechanism may be used to further confirm product availability. In one example, the verification at step 758 is performed in response to a customer selection of an item as shown in FIG. 2C. The verification may alternately or additionally be performed in response to the initial reservation inquiry provided by a customer as shown in FIG. 2D. The verification may alternately or additionally be performed when the user confirms a reservation request as shown in FIG. 2E. The system may interface to an inventory API provided by a merchant or access website data associated with the merchant to electronically verify inventory. Electronic inventory verification may be performed when an item is added to a virtual cart in one example. In other examples, electronic inventory verification may be performed in response to a request to checkout or proceed with a reservation.

For each reservation request, the system generates one or more messages to the retail locations associated with the reservation request at step 760. The system determines the retail locations specified in the reservation request and sends a message to each retail location. The system implements a centralized bus messaging service that permits messaging according to many different protocols. Each merchant may select a preferred communication protocol. At step 760, the message is generated and sent to each retail location according to the preferences of the corresponding merchant.

FIG. 2F depicts an example of a message 630 that may be sent to a retail location in one embodiment. The message may be an email, SMS message, message provided within a dedicated application or any other suitable message. In this example, the message identifies the product, the quantity requested, the price, the color, the customer, and rating information for the customer. The message further includes a link 632 permitting the retail location to confirm or reject the reservation request. A link may include any identifier or information that uniquely identifies a retail location's response to the reservation request or directs the retail location to a service provided by the reservation system to provide input as described hereinafter.

If the retail location selects the link, a merchant user interface is provided (e.g., by a website or application provided by the system) 640 as shown in FIG. 2G. The merchant user interface specifies the product(s), UPC and/or SKU, color, price and quantity. The merchant user interface 640 includes options to confirm or reject the reservation. The retailer user interface displays a confirmation number or other unique transaction identifier for the reservation request. In this example, the customer name and their past reservation rating are provided.

The messages at step 760 request physical inventory verification for the one or more products being reserved from the location. Inventory is physically verified using human visual confirmation in one embodiment. The retail location physically examines its existing inventory to determine whether the requested items are in-stock and physically present at the retail location. In this manner, anomalies or deficiencies in electronic inventory records can be discovered so that a customer does not arrive a retail location to discover that an item could not be reserved. Moreover, the physical inventory verification may determine that the requested items are damaged or otherwise unsuitable to fulfill the customer's reservation request. In this manner, the retail location may set aside or otherwise designate physical items for a customer's reservation prior to confirming the reservation such that the customer can be guaranteed that their requested items are in stock.

At step 762, the system receives one or more messages from the retail locations including physical inventory information. A retail location may send a message indicating that the requested items are present and capable of reservation. A retail location may send a message indicating that the requested items are not present and therefore cannot be reserved. Additionally, a retail location may send a modified reservation request. For example, a retail location may indicate that it can partially fulfill a reservation request but that one or more items cannot be reserved. Moreover, the retail location may specify alternate products that may satisfy the customer's request, such as an item in a different color, size, or brand, for example. The messages at step 762 may be received in response to the confirm or reject options provided in a retailer user interface as shown in FIG. 2G in one example.

At step 764, the system generates one or more messages to the customer. The message at step 764 may confirm or deny the customer's reservation request in accordance with the messages from the retail locations at step 762. Step 764 can include generating a single message for a reservation request or individual messages for each retail location associated with a reservation request. If the reservation request can be confirmed, the system sends information to the user indicating that the request has been confirmed. The information may further include instructions for completing the reservation. FIG. 2H depicts a message 650 that may be sent to a customer to confirm a reservation in one example. Directions to the retail locations, store operation hours, etc. may be included along with a unique transaction identifier. In one embodiment, a button is provided to enable the customer to click and receive a recommended route for picking up items from multiple retail locations based on the location addresses, the operating hours, and the traffic conditions. A button may also be provided to allow a customer to cancel or modify the reservation and/or a button to check the reservation status. The confirmation number or other unique transaction identifier can be provided to the retail location when the items are picked up to confirm that the reservation was completed.

At step 766, the system tracks the reservations. For each reservation, the system may receive a message from the retailer when a customer picks up the reserved items. For example, the system may provide the retail location with a URL or other means of generating a message to the system when the customer picks up their items. In one embodiment, the retail location may provide the customer with another unique code that the customer can provide to the system to confirm that it completed the reservation. Step 766 may also include information from the customer and/or retail location rating the other party. The customer may provide the unique code to the reservation system to confirm completion of the reservation, to receive rewards, and/or to rate the retail location, for example.

In one embodiment, when a customer picks up the items, the customer may scan a code provided to the retail location by the reservation platform to receive awards such as reward points, entry to a sweepstake, or to rate the service. A customer may be asked to enter some payment identification information such as the last 4 digits of a credit card number that was used to pay for the pickup at the time of the request. The platform may grant customers awards based on the credit card used to pay for the purchase during pickup in the store.

Although principally described with respect to products, embodiments may include reservation requests for services or other offers. For example, a reservation request may be for clothes fitting, a request for an appointment, or a request for services.

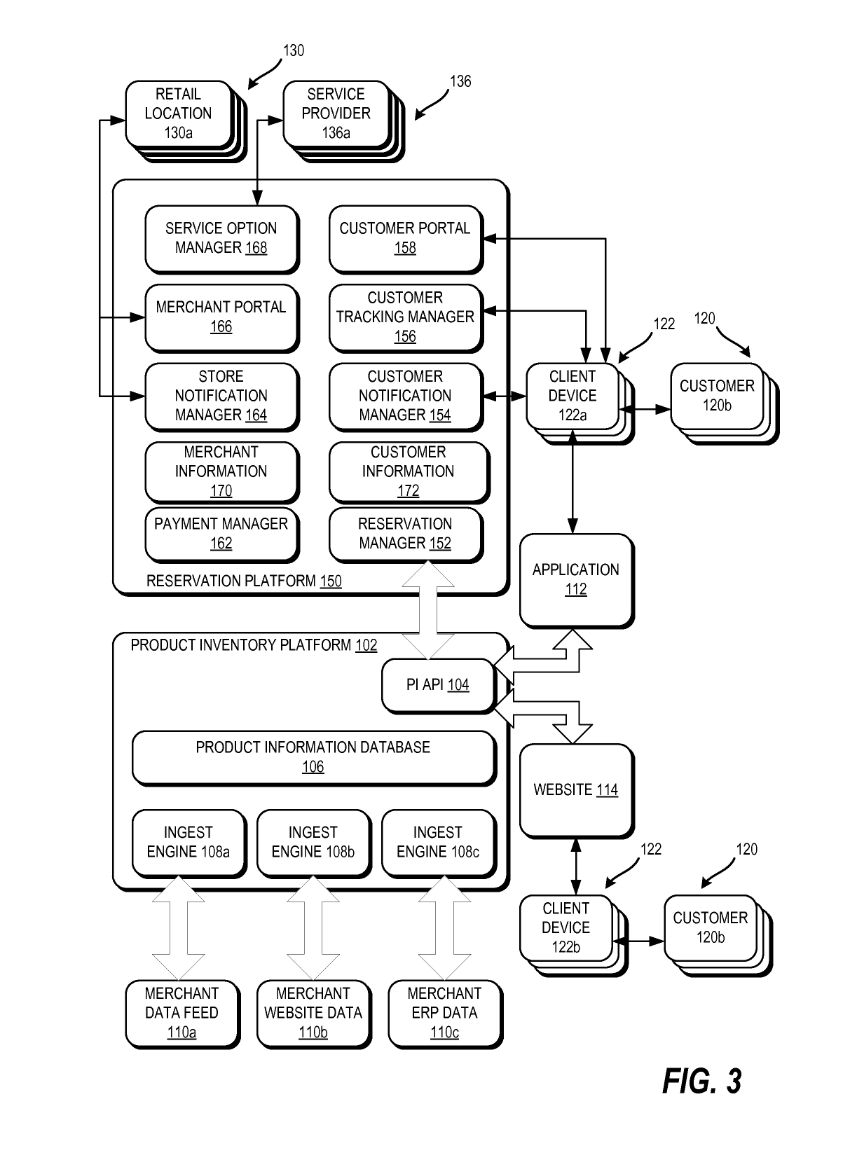

FIG. 3 is a block diagram including a computer network in which embodiments of the disclosure can be implemented. In FIG. 3, a product inventory (PI) platform 102 and a reservation platform 150 are in communication over one or more computer networks to provide a system that enables customer-driven reservation of multiple products across multiple retailers and locations based on real-time inventory information with physical inventory verification. The PI platform and reservation platform provide a customer centric electronic commerce exchange system. Reservation platform 150 and product inventory platform 102 may include one or more web servers and one or more application servers for providing various services to a plurality of customers 120, merchants operating retail locations 130, and third-party service providers 136. Various computing devices can be used and according to the requirements of a given implementation. Customers 120 generally access the product inventory platform using client devices 122 that access or execute websites 114 and/or applications 112.

The servers, client devices and other components of the system may communicate using any combination of local area networks, wide area networks (WAN), the Internet, and/or any other network. Networks typically include at least one public network such as the Internet with the various components communicating using well know communication protocols such as HTTP, HTTPs, etc. The various resource requests and messages as described herein can be transmitted using any number of well-known communication and network protocols. They can include a packet, cell, message, or signal used to ask for and receive resources. Some examples include the HTTP communication protocol over a TCP/IP network protocol, HTTPS over SSL, FTP, etc. Embodiments may be implemented using cloud computing technologies where one or more components are implemented on one or more cloud computing devices.

Client devices 122 may generally include any type of device such as a personal computer, tablet, PDA, cell phone, or other processor-based computing device. The client devices may be mobile devices or non-mobile client device may be used. Mobile devices include cellular telephones, palmtops, pocket computers, personal digital assistants, personal organizers, personal computers (PCs), and the like. Although described herein in combination with client devices, alternative embodiments can be used with any number of computer systems, such as desktop computers, other hand-held devices, laptop or notebook computer systems, multiprocessor systems, micro-processor based or programmable consumer electronics, network PCs, mini computers, main frame computers and the like.

Although databases are described for data storage in FIG. 3 other data storage techniques may be used. For example, the information may be maintained in flat files or other data structures, including unstructured schema-defined data. Embodiments may also be practiced in distributed computing environments where tasks are performed by remote processing devices that are linked through a communications network in a distributed computing environment, with programs located in both local and remote memory storage devices. Although specific components and software modules are depicted, it will be apparent that numerous physical and software based configurations may be employed while remaining within the spirit of the present disclosure. Generally, software and program modules as described herein include routines, programs, components, data structures, and other types of structures that perform particular tasks or implement particular abstract data types. Hardware or combinations of hardware and software can be substituted for software modules as described herein.

Product inventory (PI) platform 104 manages product inventory information for a plurality of different merchants that operate one or more retail locations 130. The PI platform 102 provides an interface for customers 120 and the reservation platform to access the product inventory information. PI platform 102 includes a plurality of ingest engines 108a, 108b, and 108c, implemented on one or more application servers for example. The ingest engines interface with retailers to receive inventory information associated with the retailers. Because different retailers may provide inventory information in different formats and using different inventory transfer protocols, a plurality of ingest engines are provides with individual ingest engines configured for interfacing using a particular protocol. In other embodiments, a single ingest engine configured to interface with retailers using different protocols and formats may be used.

In FIG. 3, ingest engine 108a communicates with a first retailer data feed 110a. For example, ingest engine 108a may be configured to periodically receive over a file-transfer-protocol connection one or more files containing inventory information from data feed 110a. In another example, ingest engine 108a may provide an application programming interface (API) that accesses real-time inventory information provided by a retailer in data feed 110a. Ingest engine 108b may be configured to interface with a retailers website or other application to receive product inventory information for the retailer from the retailer website data 110b. Ingest engine 108c may be configured to interface and receive product inventory information from a retailer's enterprise resource planning (ERP) data 110c. Three ingest engines are provided by way of example. In practice, PI platform 102 may receive product inventory information from many different retailers and different retail locations using any number of available formats.

The ingest engines process the information from the different retailers to generate supplier records in product information database 106. Product inventory information typically includes product information, store location information, and product availability information, but need not include each type of information and may include additional information. In one embodiment, the PI platform maintains data organized by merchant, such as by retailer, distributor or manufacturer. The PI platform maintains the organized data in merchant records in one or more databases 106. For a merchant, the product inventory information can indicate one or more locations such as retail locations associated with the merchant. For each location, the product inventory information includes location information, product information, and product availability information. The location information includes a physical address of the store location. The product information provides information for one or more of the plurality of products provided at the location. The product availability information indicates the availability of each of the one or more products, for example, indicating whether or not the product is in-stock or a number of available in-stock items. The ingest engines 108a, 108b, and 108c normalize and synchronize the data received in the various formats to a common format for storage as merchant records.

Product information database 106 also maintains information for the availability of in-store pickup of products. Merchants may define certain products as available for pickup from retail locations while defining other products as not available for reserved pickup. An identifier can be used in the merchant records to indicate the ability to reserve a product for in-store pickup. The merchant information may also specify a pickup time frame, a maximum number of products that may be picked up, a maximum dollar amount for a reservation, and other information. Retailers may specify this information in inventory data provided to the ingest engines or through merchant portal 166, describer hereinafter. The data can be added to the database by reservation manager 152 in another example.

The product information (PI) API 104 exposes the information in product information database 106 to customers 120. For example, an application 112 or website 114 may access PI API 104 to provide product inventory information to customers 120. PI API 104 enables product inventory information from database 106 to be consumed by any mobile application, e-commerce site, website, banner advertisement, digital media or message such as short-messaging-service message or social media message. Customers 120 may utilize any available website, application, or media to search for and reserve products for pickup at any one of the retailer locations 130. For example, applications 112 or websites 114 may be provided by PI platform 102 directly in one example to facilitate customer reservations. In another example, applications 112 or websites 114 are provided by third-parties by utilizing PI API 104.

Reservation platform 150 interfaces with the PI platform 102 to enable customers 120 to reserve items for pickup from retail locations 130. When a product is displayed on a client device 122a, in response to a customer search for example, PI API 104 provides an indication of whether the product is available for in-store pickup at a particular retail location. The customer may then submit a reservation request to pick up one or more items of the product from a retail location.

Reservation manager 152 manages reservations for pickup of items from retail locations. Reservation manager 152 provides a virtual shopping cart, or virtual cart for short, to facilitate a reservation system in one embodiment. The virtual cart may be provided as part of application 112 or website 114, for example. The virtual cart may also be integrated within third-party applications or websites. A customer may place items into the virtual cart. The items may be from one or more retailers and may be from one or more retail locations of the one or more retailers. When a customer places an item into the cart, the reservation manager 152 may perform an electronic inventory verification. When the customer issues a reservation request, reservation manager 152 initiates a physical inventory verification at the retail location in addition to the previously performed electronic inventory verification. When an item is placed or added to a virtual cart, the system may update or create the cart by storing a representation of the item.

Reservation platform 150 utilizes a centralized messaging system having a bus that can generate and mediate communication with customers 120 and retailers 130 over varying communication protocols. The messaging system includes a store notification manager 164, user tracking manager 156, and customer notification manager 154 in one embodiment.

The physical inventory verification is initiated by store notification manager 164 in one embodiment. In response to a reservation request for an item, store notification manager 164 generates a message to the retail location to perform a physical inventory verification of the item. Manager 164 may access retailer records 170 to determine a preferred communication for the retailer. For example, physical inventory verification messages may be communicated using electronic mail, short messaging service, voice, or other protocols. For example, a retail location may utilize client devices with dedicated communication links to store notification manager 164, or client devices with an in-store application to communicate with store notification manager 164. Retailer records 170 include preferences or settings indicating a communication protocol for communication with each retail location.

After determining the appropriate communication protocol, the manager 164 transmits a physical inventory verification message to the retail location. The message includes a request to reserve the item for pickup at the retail location in one embodiment. In one embodiment, the message to the retail location includes confirm or deny options for the retail location to provide input. In another example, the message may include a link or other locator for an application or website enabling the retail location to confirm or deny the request. An employee or other person at the retail location physically verifies whether the retail location includes the requested item. After physically verifying inventory of the item, the retail location may confirm the reservation request or deny the reservation request using the link or confirm or deny options in the message.

In one example, an email message may be sent to the retail location with options to confirm or deny the reservation request by user input. If the employee confirms the reservation by selecting the confirm option, an email message may be generated in reply to store notification manager 164 indicating that the item is available and the reservation is confirmed. If the employee denies the reservation by selecting the deny option, an email message may be generated to store notification manager 164 indicating that the item is unavailable and the reservation is not confirmed. In other example, the employee may enter an available number of the items when the available number is less than the requested number. In another example universal resource locator (URL) links may be provided in a physical inventory verification email to allow an employee of a retailer to select a link confirming or denying a reservation request. A link to an application, website, or web service provided by the platform is provided to enable the retail location to confirm or deny the reservation in one embodiment. Similar to email messages, an SMS message may be sent to a retail location with options to confirm or deny the reservation request. In another example, a dedicated application is provided for client devices at the retail location. The client devices may receive messages from the platform and provide means to generate reply messages for confirmation or denial of reservation requests.

When the store notification manager 164 receives a reservation confirmation message from a retail location, the customer notification manager 154 generates a confirmation message to the corresponding customer using the customer's preferred message protocol indicated in customer records 172. The confirmation message sent to the customer 120 can include various information relating to the reservation. For example, the message may include instructions for picking up the requested item(s), directions to the retail location, payment information, etc. If the store notification manager 164 receives a reservation denial message from a retail location, it generates a denial message to the corresponding customer. To customers, the platform offers the choice of preferred communication means to interact with merchants and the platform regarding reservation requests. This enhances consistent shopping experience of customer-focused system such that customers do not have to be troubled with the reservation capability of individual merchants, and can always interact with any store in their preferred communication protocol.

In the described manner, platform 150 may receive a customer reservation request via a website 114 or application 112, then generate and receive physical inventory verification messages with multiple requested retail locations using different message protocols associated with different ones of the retail locations. Platform 150 may further generate and receive messages with a corresponding customer using a communication protocol selected by the customer, independent of communication via the website 114 or application 112.

In this manner, the notification managers provide a messaging platform that can be visualized as an interconnecting bus with built-in protocol and process translations to interface with disparate systems. It provides intelligence regarding fulfillment ability and desirable command and control capability at each retail location. It offers an array of commands and controls configurable to communicate with a retail location at different locations. Integration with legacy systems and/or corporate IT infrastructure at various stages of implementation is thus provided. The messaging platform can mediate communication between the plurality of merchants and the plurality of customers using an interconnecting bus with reservation protocol and process translations. The bus interfaces with a plurality of disparate communication systems provided by the plurality of merchants.

Customer information 172 is maintained by reservation platform 150 in one or more databases or other storage devices. Customer information 172 includes customer profiles. Each customer profile includes account information such as a username and password that is used to authenticate a customer when utilizing an application 112 or website 114. A customer profile also includes customer preferences. In one embodiment, customer preferences are explicitly defined by the customer. In another embodiment, the customer preferences are defined or supplemented by the reservation platform based on past shopping behavior of the customer. Customer preferences can include a service provider preference indicating a merchandiser preference such as which store location of a merchant the customer prefers as well as pickup and delivery service provider preferences. A communication protocol preference can also be provided indicating a preferred method of communication with the reservation platform so that the customer is able to use consistent communication protocols regardless of what communication protocols are used by a retail location. A customer can indicate preferences for communication via email, SMS, telephone, or by other message protocols. A customer may list more than one preference to provide alternate means for communication in the event a primary communication protocol preference is unavailable. The customer preferences can also include brand preferences and payment method preferences. Payment method preferences may include payment information, such as credit card or bank account information. The payment information may be used to process payments for items that are reserved for pickup using platform 150, although payment is not always required. Payment information may include information for more than one payment type and an indication of a primary payment method, for example. The customer preferences are used for detailed filtering in the reservation process in one embodiment. Search results can be delivered based on location, brand, merchandiser, and/or payment preferences. Moreover, these preferences may be used to filter communications and payments for the customer. Customer profiles may be defined by preferences supplied by the customer or may be generated or supplemented based on past shopping behavior of a corresponding customer.

A customer portal 158 is provided in one embodiment, accessible through a website or application for example to enable customers 120 to manage account information and reservation transactions. A customer may access portal 158 to establish or modify payment information or communication protocol preferences. Customers may also access portal 158 to view pending and past reservations of the reservation platform 150. For example, a customer may cancel or modify a reservation via user portal 158. Customer tracking manager 156 permits customers to track the status of reservations. Customers may also access the tracking manager to change pickup options.

In one embodiment, merchant information 170 is maintained by reservation platform 150 in one or more databases or other storage devices. Merchant information 170 includes merchant records. Each merchant record includes account information such as a username and password that is used to authenticate a merchant accessing the reservation platform. A merchant portal 166 is provided by reservation platform 150, as a website in one example, although other user interfaces may be used. The merchant portal allows the merchant to set preferences for communication protocols to use when processing reservation transactions for retail locations of the merchant. As with customers, a merchant can indicate preferences for communication via email, SMS, telephone, or by other message protocols and may provide more than one preference to indicate alternate means for communication in the event a primary communication protocol preference is unavailable. A merchant record may further include account information, such as merchant account information for depositing payments to the merchant from customers 120.

Merchant information 170 may include a record for each retail location of retailers with multiple locations. In this manner, transaction information for reservations may be maintained specifically for each retail location. Additionally, this permits communication protocol preferences to be established for individual locations and account information to be provided for the individual store locations. In one embodiment, merchant information 170 is maintained in product information database 106.

Payment manager 162 interfaces with the reservation manager 152 to facilitate payments for items that are reserved for pickup at a retail location as well as other payments, such as for products that will be shipped by a merchant, rather than picked up by a customer. The payment manager 162 can electronically transfer payment information to a merchant or retail location for processing in one embodiment. In one embodiment, the payment manger 162 accepts payment information from a customer and executes a transaction where funds are debited against a customer's account (e.g., credit card account) and deposited into a merchant account associated with the merchant. The merchant or a retail location can setup a merchant account or provide information for a merchant account in retailer information 170 in one example. In another example, merchant account information is stored in product information database 106. In another embodiment, the payment manager 162 can accept payment from the customer and later reconcile accounts by depositing funds into an account, merchant or otherwise, that is associated with the merchant.

The payment manager 162 implements multiple payment protocols in one embodiment to facilitate transactions with merchants having different infrastructures and/or requirements for payment of items reserved for pickup. In one example, a merchant may not require pre-payment for items. In such a case, if a customer requests reservation of an item from the merchant, the reservation will be completed with the retail location and confirmation granted to the customer without any payment.

In another example, a merchant may require pre-payment of items that are reserved for pickup. According to one payment protocol, the payment manager 162 pre-authorizes an amount for the items of a reservation on an account such as a credit card of the customer. Information regarding the pre-authorization is made available through merchant portal 166. When the customer arrives at the retail location to pick up the reserved items, the customer can present their account information or credit card. The merchant can process the order locally at the retail location like a normal transaction. The merchant can access retailer portal 166 to cancel the pre-authorized amount on the customer's account. In another embodiment, the merchant can access retailer portal 166 to capture the pre-authorized amount from the customer's account. As earlier described, the payment manager 164 may also capture the payment for a customer, directly applying the transaction amount to the customer's account rather than pre-authorizing the amount for the items.

In another example where a merchant requires payment at the time of reservation, the payment manager 162 can interface with an application programming interface provided by the corresponding merchant to facilitate payment. The payment manager may directly integrate with a merchant's information technology (IT) infrastructure. In this example, the payment manager submits the transaction information directly to the merchant through their payment and purchase API for processing by the merchant directly. In these instances, payment is handled entirely by the merchant.

In yet another example where a merchant requires payment at the time of reservation, the payment manager 162 can interface with a merchant's e-commerce website or application to process payment for items of a reservation. The payment manger integrates with a merchant's e-commerce site to provide integration with the checkout page of the site. The payment manager can load the checkout page of the merchant, supplying the requested items, payment information, and shipping information for example. The shipping address can be the address of the retail location from which the items will be picked up. The payment can then be processed directly by the merchant using their e-commerce site. The merchant's site can return an order number and details regarding the order receipt. This information can be sent to the customer via user notification manager 154 as part of the confirmation message sent when the retail location verifies physical inventory.

Service option manager 168 interfaces with one or more third-party service providers 136. A customer may engage a third-party service provider as part of their reservation. For example, during checkout a customer may specify a third-party concierge service that will pick up the items in the reservation. A customer may also access user portal 158 to manage reservations, including changing pickup, delivery and third-party options. Thus, a customer may access user portal 158 and provide third-party information for a service provider that will pick up one or more of the items in the reservation. Service option manager 168 interfaces with the service providers to provide reservation information to enable completion of the service. For example, service option manager 168 may send a message to a concierge service provider with order information required to pick up each of the items in the reservation.

One implementation may include an application or website that exposes product inventory information via PI API 104 for a group of stores such as at a mall or other common location. A customer may search for items available from the different merchants at the mall using the application or website. The customer may place items from different merchants at the mall into a virtual cart and checkout using the single virtual cart. A single checkout can be used to reserve items for pickup from multiple ones of the merchants at the mall. During checkout, the customer may designate that a third party service provider 136 such as a concierge service will pick up the items. Indeed, the mall itself may offer such a concierge service. After checking out, the reservation platform physically confirms the availability of the items form the different merchants and mediates communication with the merchants to confirm the reservation requests. The reservation platform may communicate with the customer and/or the concierge service to confirm the reservation requests as described above. The concierge service can then pickup each of the items and hold them at a central location for pickup by the customer.

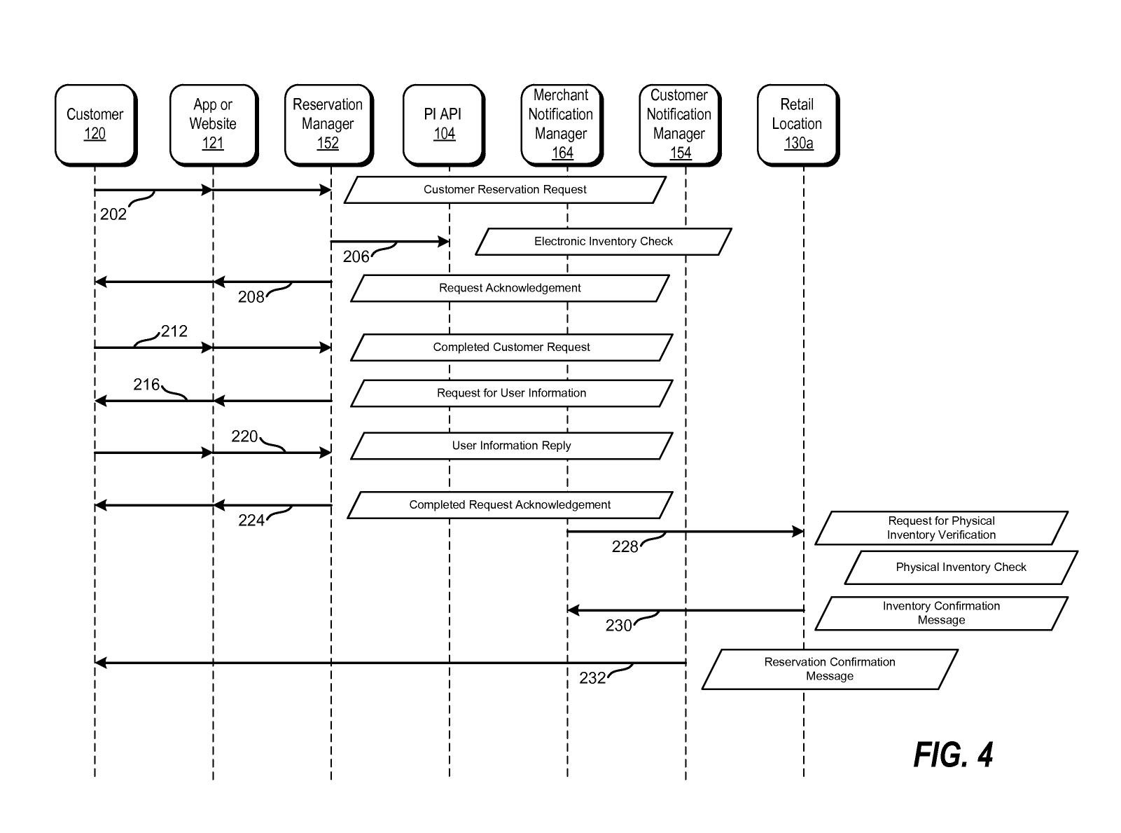

FIG. 4 is a timing diagram depicting communication with reservation platform 150 and product inventory platform 102 to complete a reservation request for a customer 120 with a retailer's store 130 in one example. Customer 120 accesses an application 112 or website 114, hereinafter referred to collectively as site 121 for convenience. The site may offer search functions that access product inventory API 104. The site may be an advertisement, generated by an advertisement engine that interfaces with API 104, and that offers the opportunity for a customer to click an item for reserved pickup at a local retail location as described.

Customer 120 issues a reservation request 202 through site 121 for one or more products to be picked up from one or more retail locations. The reservation request may travel through the site in one example. For example site 121 may redirect an HTTP request corresponding to request 202 from site 121 to reservation manager 152. In another example, a reservation request may be issued directly from the customer to reservation manager 152. For example, site 121 may provide a button or other input mechanism that when selected by the customer, directly links to reservation manager 152.

The reservation manager 152 receives the reservation request 202 and issues an electronic inventory check or verification 206 to the product inventory database using PI API 104. Although shown as verifying inventory using PI API 104, other means for electronically verifying inventory in response to a reservation request may be used. For example, PI API 104 may actively verify inventory for any results initially presented to the customer 120 before a reservation request. Accordingly, reservation manager 152 may electronically verify inventory using a secondary source. A federated inventory check is performed in one example. A federated inventory check may be performed using a direct store API in one example. In another, the federated inventory check may be performed by accessing an inventory check button or other input mechanism provided by an e-commerce site of the merchant.

Reservation manager 152 acknowledges the customer reservation in reply 208. If the electronic inventory verification 206 verifies inventory for the selected items at the selected retail location(s), the acknowledgement reply can request that the customer confirm their reservation request. If the electronic inventory verification 206 verifies a portion of the selected items, the acknowledgement reply can indicate that portion of the request that can be fulfilled by the retail location(s) and ask if the customer wishes to proceed with the modified reservation. The customer then issues a reply 212 to reservation manager 152 confirming or cancelling the reservation request.

If the user confirms the reservation request in reply 212, the reservation manager 152 issues a request 216 for customer information to complete the reservation request, if needed. For example, the reservation manager 152 may request that the user provide login credentials previously established with the reservation platform. The customer may alternately provide the needed customer information directly in the event that no customer account has been created. If the user is already logged in to platform 150, request 216 can be omitted.

The provided login or customer information is transferred to the reservation manager 152 in reply 220. After receiving customer information, reservation manager 152 issues a completed request acknowledgement 224 to the customer. The completed request acknowledgement includes a unique transaction identifier for the reservation request.

In response to a customer's completed reservation request 212 or a customer information reply 220, store notification manager 164 begins a physical inventory verification process at the corresponding retail locations. Store notification manager 164 may first access merchant information to determine the necessary messaging protocols for communicating with each required retail location. In this example, a single retail location is presented for clarity of explanation but it will be appreciated that operations by the store notification manager may be repeated for as many retail locations as necessary.

After determining the appropriate messaging protocol for retail location 130a, the notification manager 164 generates message 228 for the reservation request. Message 228 includes a request for the retail location to physically verify the requested items for the reservation. The retail location 130a performs a physical inventory verification for the requested items in response to message 228. The physical inventory verification extends beyond traditional electronic inventory management mechanisms and provides the customer with confidence that reserved items will be available when the customer arrives at the retail location. In one embodiment, a physical inventory verification comprises the retail location verifying the physical presence of the requested items within the retail location premises. An employee, for example, may physically examine the store's inventory to visually or otherwise confirm that the requested item(s) is present.

The physical inventory verification enables the retail location to select and earmark specific items of a requested product for the reservation request. In this manner, the reservation request enables customers to reserve specific items at a retail location and have those specific items set aside for the customer. This transforms the reservation from an abstract reservation of one or more products to a reservation and earmarking of specifically identifiable items for the customer.

Message 228 may also include the unique transaction identifier for the reservation request that was forwarded to customer 120. The unique transaction identifier enables the merchant location to link the reservation to the customer when the customer arrives to pick up the reserved items. In instances where a reservation request includes items from more than one retail location the reservation platform may generate more than one transaction identifier for the reservation request. Each transaction identifier may be associated with one retail location so that the reservation platform may track the portions of the reservation specific to each retail location.

Message 228 may also include means for the retail location to confirm, deny or modify the reservation request. For example, message 228 may include URL's corresponding to confirmation or denial of the reservation request. Selecting a confirmation URL may send an http or other request to reservation manager 152 indicating the retail location has accepted and confirmed the reservation request. Selecting a denial URL may send an HTTP or other request to reservation manager 152 indicating that the retail location has rejected the reservation request. The message 228 may also include a URL to a webpage or location provided by the platform to confirm, deny or modify the reservation request. For example, the merchant location may indicate that some items in the request can be reserved while others cannot. In other examples, message 228 may include URL's that cause SMS messages, email messages, voice messages, or other means of confirming, denying, or modifying the reservation request. Message 228 may also include a quick response (QR) or other code to indicate a reservation. The message may include a bar code and/or stock keeping unit (SKU) of each item in the reservation request. A store employee or associate may print out the request notification and tape it to or otherwise associate it with the reserved items. When a customer picks up the items, the customer may scan the QR code, using a smartphone for example, to receive awards such as reward points, entry to a sweepstake, or to rate the service.

Retail location 130a issues a reservation reply 230 after performing the physical inventory verification. The reservation reply 230 may be generated and issued to the merchant notification manager 164 by selecting a URL or other input means in message 228, for example. Although shown as being issued to the notification manager 164, the retail location reply 230 may be transmitted directly to reservation manager 152 in one embodiment. For example, the URL or other means in message 228 may include a link to a website or application provided by the platform. It is noted that retail locations may deny a reservation request for any number of reasons. In one example, a retail location may set a threshold to reject reservation requests from customers having a low rating based on their trustworthiness as determined from their past pickup history.

After receiving the physical inventory verification information from the retail location, the customer notification manager 154 generates a reservation confirmation message 232 and transmits the message to customer 120. If the retail location physically verifies inventory of the requested items, the customer notification manager 154 confirms the reservation and provides pickup information for the requested items in message 232. If the retail location denies the reservation request, the confirmation message can indicate that the reservation request could not be honored. Message 230 may include information for obtaining the items from another retail location, another merchant, etc. in one embodiment. If the retail location modified the reservation request, for example to indicate that some but not all of the requested items were available, message 230 may ask the customer to confirm whether they want to proceed with the modified reservation or whether they wish to cancel the reservation request. As earlier mentioned, a reservation request may include items from more than one retail location associated with one or more merchants. In one example, customer notification manager 154 generates a single confirmation message 232 with the results of physical inventory verification at the various retail locations. In another example, customer notification manager 154 generates a confirmation message 232 for each of the retail locations (or some combination of retail locations) associated with the reservation request.

Within the pickup time, a customer who has made a reservation may click a button in the reservation message from the reservation platform to change the reservation from pick-up to delivery. This could be done through a button in reservation notification email or a URL link in an SMS reservation notification or customer portal for example. The customer may also click a button or URL link in an email or SMS message or through a customer portal to notify the store and/or endorse that a third-party will be picking up the reserved items.

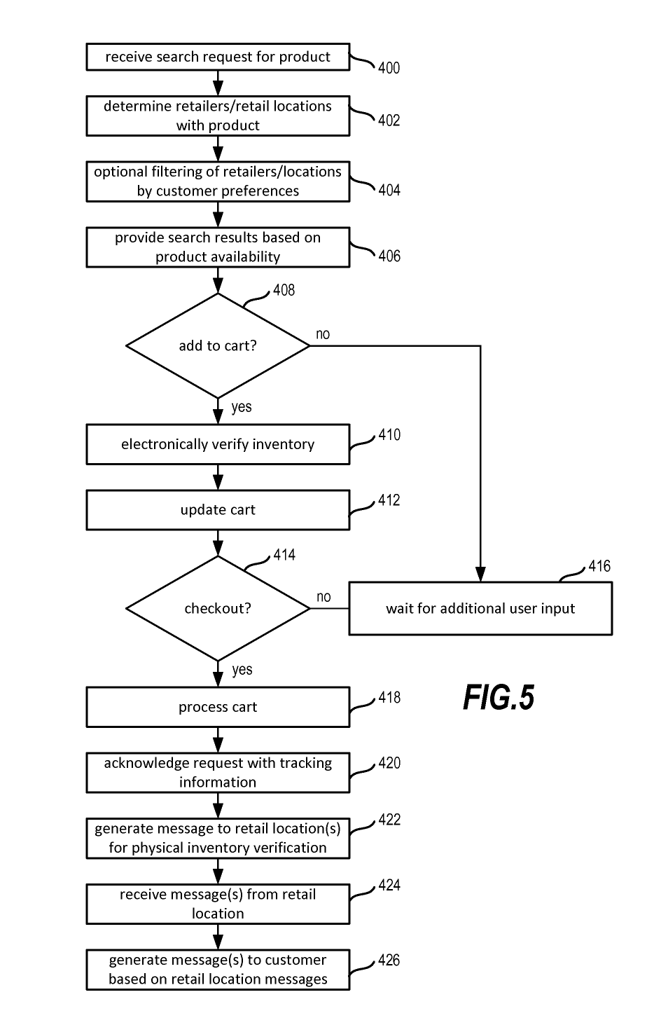

FIG. 5 is a flowchart describing operation of reservation platform 150 and product inventory platform 102 in one embodiment. At step 400, a search request for a product is received by the PI platform via PI API 104. The PI API 104 determines one or more merchants and one or more retail locations with an available inventory of the product according to product information database 106. At step 404, the PI API optionally filters the retail locations according to customer preferences maintained in customer information 174 or elsewhere. For example, a customer may specify one or more preferred merchants or merchant locations such that PI API 104 returns results for the preferred retailers if the item is available there. The results may also be filtered by the customer's location. A location at time of search may be used when the user is interfacing with the platform via a mobile client device. The location may be determined by location information provided by the customer, GPS or other location information generated by a client device, or by an IP address of the access point where the user's device accesses the Internet, for example. At step 406, the PI API returns results to the search request based on product availability. The PI API may return one or more retail locations with an available inventory of the requested product. In one example, the PI API returns a number of items of the requested product at the retail location. It is noted that the search request need not originate from a customer. For example, an ad generation engine or other software application may interface with PI API 104 to obtain search results regarding product inventory and the availability of products for reserved pick up. PI API 104 may provide an indication in the search results of step 406 that a product is available for reserved pickup at a retail location as determined from product information database 106.

At step 408, the reservation platform determines whether it has received a request to add items to a shopping cart for a customer. If the reservation platform has not received a request to add items to a cart, it awaits further customer input at step 416. When the reservation platform receives a request to add items to a cart, it may first allocate or create a cart for the customer session. The reservation platform provides a virtual cart in one embodiment, enabling the customer to add items from different merchants and different retail locations within a single cart.

When a customer adds an item to a cart, reservation manager 152 electronically verifies the product inventory at step 410. In one example, reservation manager 152 issues a request via PI API 104 to reconfirm the product availability at the designated merchant location. In another example, reservation manager 152 performs a federated inventory check by accessing a merchant API or e-commerce site to determine available inventory of the requested product. If the requested retail location has an available inventory of the requested product, reservation manager 152 updates the virtual cart for the customer at step 412. Updating the virtual cart when a product is added may include adding a store identifier, a product identifier, a description of the product, the price of the product, the quantity of the item requested, and other information. The virtual cart may also be updated to include an indication of whether the item is being reserved for pickup and whether prepayment of the item is required. That is, when an item is added to the virtual cart, fields for the added item are provided including a store identification, an indication of whether the item may be reserved for pickup, and an indication of whether payment is required to reserve the item for pickup.

At step 414, reservation manager 152 determines whether it has received input from the customer indicating that it wishes to checkout or otherwise complete a reservation request for the items in its virtual cart. If no indication to checkout is provided, the reservation platform waits for additional user input at step 416.

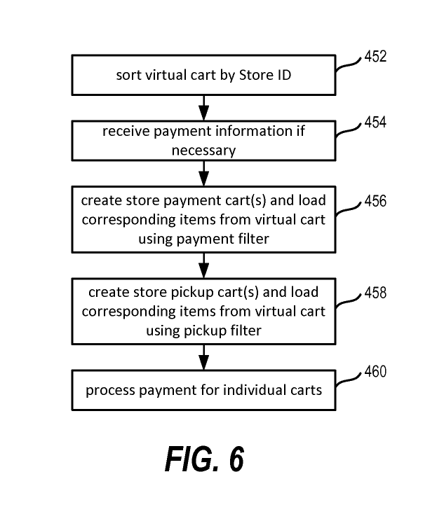

When reservation manager 152 receives input indicating that a customer wishes to checkout or complete a reservation request for the items in its cart, the reservation platform processes the cart at step 418. For example, the payment manager may process any payments required for any items in the cart. More details on processing a virtual cart are provided in FIG. 6.

At step 420, the reservation manager 152 issues a reply to the customer with tracking information for the reservation request. The reply acknowledges the reservation request and indicates that the reservation platform is confirming availability and pickup information for the requested items. The reservation platform may provide an estimated time for confirming item availability in the reply. The tracking information includes a unique identifier for the reservation request in one embodiment. When the reservation request includes more than one retail location, the tracking information may include a transaction identifier for each retail location.

At step 422, the store notification manager generates messages to the retail locations specified in the reservation request. Step 422 may include generating messages in different message protocols for different retail locations. By way of example, the notification manager may communicate with retail locations using proprietary communication protocols, email, SMS messaging, voice, HTTP, etc. Because of the varying requirements of merchants, the notification manager may generate messages using numerous different protocols at step 422 to facilitate communication with the various retail locations.

In one embodiment, the message is a reservation request sent directly to devices operated by employees of the retail location. For example, messages using inventory management systems may be generated. In one example, the store notification manager also generates a phone call or SMS message to the retail location to alert the location of the reservation request. In one embodiment, a retail location may download an application to a mobile or other device from the reservation platform. The application can provide real-time product availability information and other information between the retail location and the reservation platform. For example, the application may enable the processing of returns, the receipt of service reports, etc. In one example, the application permits the retail location to send instant messages or audio messages to the customer.

At step 424, messages are received from the different retail locations specified in the reservation request. At step 426, the user notification manager generates one or more messages to the customer based on the messages from the retail locations. If the availability of all requested items is physically verified, manager 154 generates a message to the customer confirming the requested reservation. If no items are available for a request, manager 154 generates a message to the customer denying the reservation request. In one example, the reservation platform determines alternate retail locations for fulfilling the reservation request and provides an option to the customer to proceed with an alternate reservation of the items at the new location(s). If part of a reservation request can be fulfilled but part cannot, the reservation platform generates a message with an option to proceed with the partial reservation or to otherwise modify the reservation. As earlier described, manager 154 may generate an individual message to the customer corresponding to the individual retail locations specified in the reservation request in one embodiment. In another example, manager 154 may send a message to a customer with reservation information for a number of retail locations that have responded within a certain time frame. Additional messages may be sent as additional reservation information is received from the retail locations. The additional messages may group reservation information for retail locations responding within other time frames.

When a customer arrives at a retail location to fulfill a reservation request, they may present the transaction identifier to the retail location for verifying the transaction. In one embodiment, the retail location may access merchant portal 166 to indicate that the reservation was completed by the customer. The reservation platform may use the information to generate ratings for customers. These ratings are provided as part of a reservation request to a retail location in one embodiment. In one embodiment, the reservation request sent from the reservation platform to the retail location may include a URL or other mechanism for the retail location to verify that the customer completed the transaction.

In one example, a customer may be requested to provide verification information when they pickup items from a retail location. For example, a user may be asked to confirm the last 4 digits of their credit card number, bank account number (e.g., for eChecks or ACH), order number, and/or to provide a picture ID.

FIG. 6 is a flowchart describing processing of a virtual cart provided by the reservation platform in one embodiment. In one example, the process of FIG. 6 can be performed at step 418 of FIG. 5. At step 452, a virtual cart is sorted by a store identifier associated with each item in the cart. As earlier described, when items are added to the virtual cart, a store identifier is added for each item in addition to traditional item information to enable the simultaneous reservation of items from multiple retail locations. Accordingly, step 452 sorts the items in the virtual cart according to store identifier. The sorted virtual cart information can be presented to the user in one example.

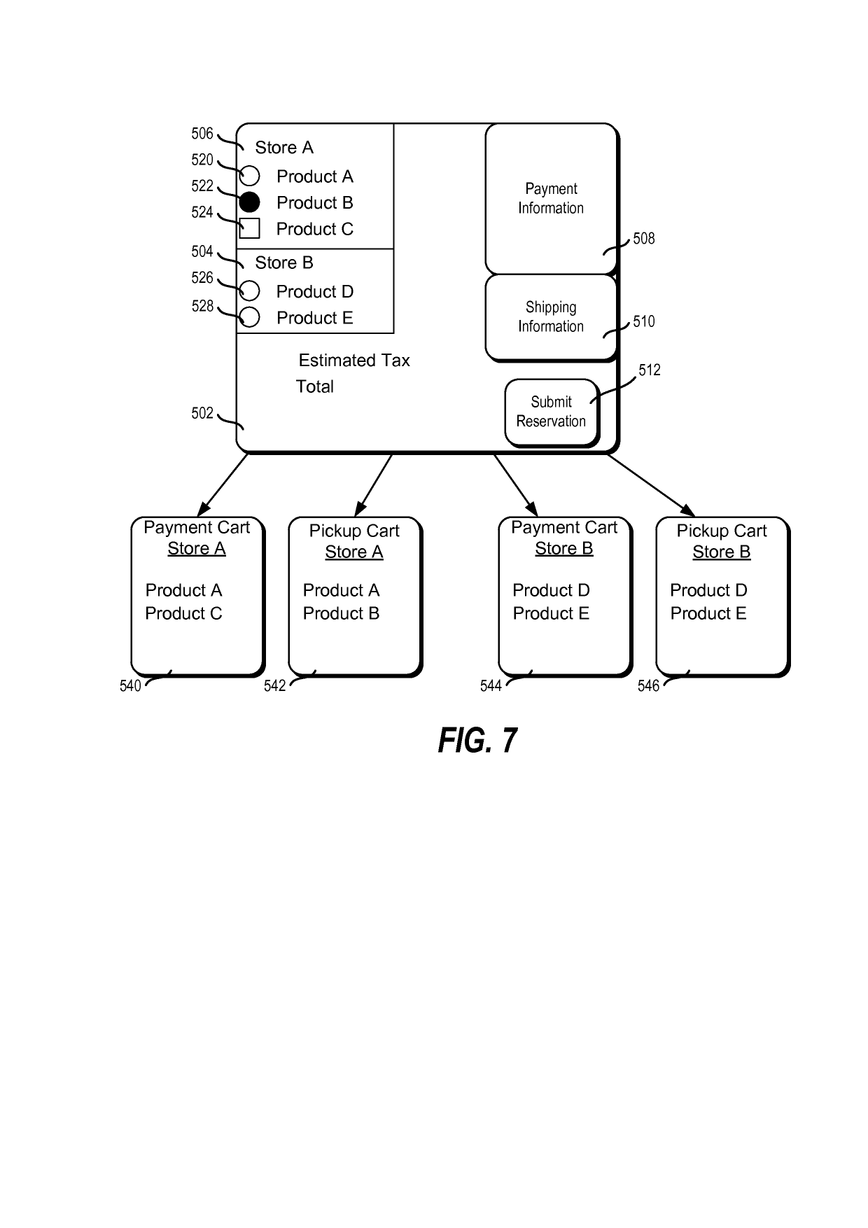

FIG. 7 is a block diagram depicting a virtual cart 502 in one example. In this example, the virtual cart includes items from a first retail location Store A and a second retail location Store B. The items have been sorted into list 506 for items from Store A and list 504 for items from store B. The customer has added Product A, Product B, and Product C to the virtual cart from Store A and Product D and Product E to the virtual cart from Store B. Although not shown, the virtual cart may also depict the price of each item from the store. Moreover, the reservation platform may store additional information for the virtual cart such as a product number, SKU, or product description, etc.

For each item in the virtual cart, reservation manger 152 provides an indication of whether the item is designated for shipment, reserved in-store pickup with pre-payment, or reserved in-store pickup without pre-payment. In this particular example, Product A includes anindication 520 that the item is being reserved for pickup and that payment is required to complete the reservation for the item. Product B includes an indication 522 that the item is being reserved for pickup and that the item does not require payment before the item may be reserved for pickup. Product C includes an indication 524 that the item is being purchased for delivery. It is noted that customers may be provided the option to pay for items being reserved for pickup even when pre-payment is not required by the retail location. For store B, Product D includes an indication 526 and Product E includes an indication 528, both of which indicate that the products are being reserved for in-store pickup and that the items require pre-payment.

At step 454 of FIG. 6, reservation manager 152 requests payment information from the customer if needed. FIG. 6 depicts customer payment information 508 and shipping information 510 in virtual cart 502. If the customer was previously logged in to the reservation platform, the payment information and shipping information may be retrieved from customer information 172. If the customer is not logged in, reservation manager 152 requests that the customer login or issues one or more requests to the user to provide customer, payment, and shipping information as necessary for completing the reservation request. Virtual cart 502 further displays an estimated tax for the reserved items and a total amount that will be charged against the customer's account for the reservation. The virtual cart may display an estimated tax and total amount associated with each retail location in one embodiment. In another embodiment, the system may solicit the customer to enter additional information such as coupons or loyalty rewards to be applied against payment amount.

The virtual cart includes a submit reservation button 512 or other form of receiving a customer indication that they wish to place the order and submit the reservation and have any payments processed. Selection of the button 512 generates a request to reservation manager 152 indicating that the customer wishes to finalize the reservation as indicated in the virtual cart. In one embodiment, the virtual cart may display buttons for each store, allowing the customer to separately confirm a reservation for each store indicated in the virtual cart. Moreover, the user may provide different payment and/or shipping information for different stores.

At step 456 of FIG. 6, reservation manager 152 creates one or more store payment carts for the virtual cart. Step 456 may be performed in response to user input received by submit reservation button 512 in FIG. 6, for example. Store payment carts are created for each store for which items are being reserved and that require payment. The store payment carts are populated with data from the corresponding items in the virtual cat. In FIG. 7, reservation manager 152 generates a store payment cart 540 for Store A and a store payment cart 544 for Store B. Cart 540 is populated with data from items in the virtual cart for Store A that require payment, either for reserved in-store pickup or for delivery. Accordingly, cart 540 is populated with data for Product A and data for Product B. Product A is designated for pre-payment for in-store pickup and Product C is designated for delivery. Cart 540 may include an item number, price, description, tax and any other information associated with purchase of the designated items. Cart 544 is populated with data for Product D and Product E. Both products are designated for pre-payment and reserved in-store pickup.

At step 458 of FIG. 6, reservation manager 152 creates one or more store pickup carts for the virtual cart. Store pickup carts are created for each store for which items are being reserved for in-store pickup. The store pickup carts are populated with data from the corresponding items in the virtual cart. In FIG. 7, reservation manger 152 generates a store pickup cart 542 for store A and a store pickup cart 546 for store B. Cart 542 is populated with data for Product A and data for Product B. Cart 546 is populated with data for Product D and Product E.

At step 460 of FIG. 6, the store payment carts are processed for each store. As earlier noted, payments may be processed according to merchant preferences, stored in merchant information 170 for example. Accordingly, step 460 may include processing different carts using different payment protocols. For example, payment cart 540 may be processed to pre-authorize an amount to a customer's credit cart, designating store A as the merchant account to receive payment. On the other hand, cart 544 may be submitted to store B through a designated API for example, for direct integration and processing by Store B's payment and purchase infrastructure. Additionally, cart 540 or 544 may be processed by loading data from the cart to a cart or checkout page of a corresponding merchant having an online presence.

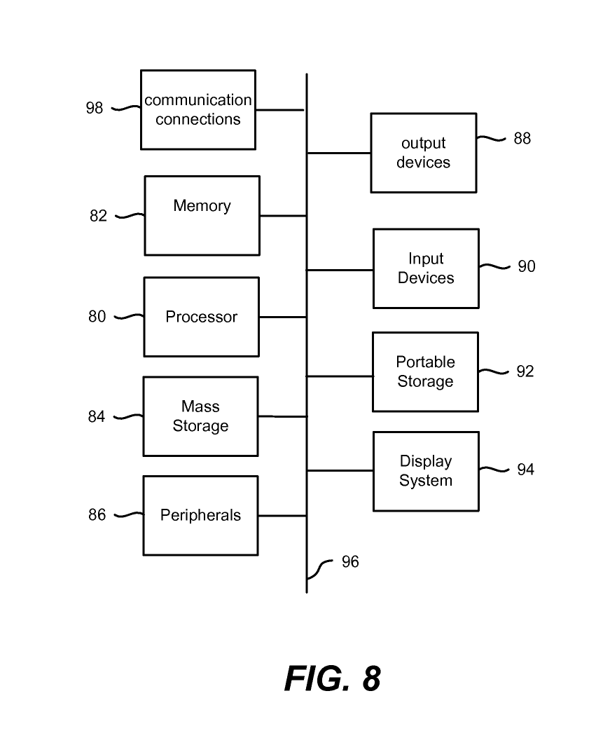

FIG. 8 is a high level block diagram of a computing system which can be used to implement any of the computing devices described herein. The computing system of FIG. 8 includes processor 80, memory 82, mass storage device 84, peripherals 86, output devices 88, input devices 90, portable storage 92, and display system 94. For purposes of simplicity, the components shown in Figure Bare depicted as being connected via a single bus 96. However, the components may be connected through one or more data transport means. In one alternative, processor 80 and memory 82 may be connected via a local microprocessor bus, and the mass storage device 84, peripheral device 86, portable storage 92 and display system 94 may be connected via one or more input/output buses.

Processor 80 may contain a single microprocessor, or may contain a plurality of microprocessors for configuring the computer system as a multiprocessor system. Memory 82 stores instructions and data for programming processor 80 to implement the technology described herein. In one embodiment, memory 82 may include banks of dynamic random access memory, high speed cache memory, flash memory, other nonvolatile memory, and/or other storage elements. Mass storage device 84, which may be implemented with a magnetic disc drive or optical disc drive, is a nonvolatile storage device for storing data and code. In one embodiment, mass storage device 84 stores the system software that programs processor 80 to implement the technology described herein. Portable storage device 92 operates in conjunction with a portable nonvolatile storage medium, such as a floppy disc, CD-RW, flash memory card/drive, etc., to input and output data and code to and from the computing system of FIG. 7. In one embodiment, system software for implementing embodiments is stored on such a portable medium, and is input to the computer system via portable storage medium drive 92.

Peripheral devices 86 may include any type of computer support device, such as an input/output interface, to add additional functionality to the computer system. For example, peripheral devices 86 may include one or more network interfaces for connecting the computer system to one or more networks, a modem, a router, a wireless communication device, etc. Input devices 90 provide a portion of a user interface, and may include a keyboard or pointing device (e.g. mouse, track ball, etc.). In order to display textual and graphical information, the computing system of FIG. 8 will (optionally) have an output display system 94, which may include a video card and monitor. Output devices 88 can include speakers, printers, network interfaces, etc. The computing system may also contain communications connection(s) 112 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computing system of FIG. 8 are those typically found in computing systems suitable for use with the technology described herein, and are intended to represent a broad category of such computer components that are well known in the art. Many different bus configurations, network platforms, operating systems can be used. The technology described herein is not limited to any particular computing system.

The technology described herein, including the advertising platform and product inventory platform can be implemented using hardware, software, or a combination of both hardware and software. The software used is stored on one or more of the processor readable storage devices described above (e.g., memory 82, mass storage 84 or portable storage 92) to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more computer readable media/storage devices, peripherals and/or communication interfaces. In alternative embodiments, some or all of the software can be replaced by dedicated hardware including custom integrated circuits, gate arrays, FPGAs, PLDs, and special purpose computers.

The foregoing detailed description has been presented for purposes of illustration and description. It is not intended to be exhaustive or to limit the invention to the precise form disclosed. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer readable storage medium having computer readable instructions for programming a processor to perform a method, the method comprising:
providing an electronic database including product information associated with a plurality of merchants, each merchant having one or more retail locations;
receiving a customer request to reserve a first product for pickup from a first retail location;
generating a message to the first retail location for physical inventory verification of the first product at the first retail location;
receiving a message from the first retail location with physical inventory information for the first product; and
generating a message to the client device including reservation information for the first product at the first retail location if the physical inventory information indicates that the first product is present at the first retail.

2. A computer readable storage medium according to claim 1, wherein:
the message to the first retail location requests physical inventory verification of the first product at the first retail location with explicit human intervention.

3. A computer readable storage medium according to claim 2, wherein:
generating the message to the first retail location for physical inventory verification of the first product at the first retail location provides a man-machine interface to physically verify a requested product availability at the first retail location.

4. A computer readable storage medium according to claim 1, further comprising:
electronically verifying an available inventory of the first item at the first retail location;
wherein generating the message to the first retail location is performed in response to electronically verifying that there is available inventory of the first item at the first retail location.

5. A computer readable storage medium according to claim 1, wherein:
the physical inventory information in the message from the first retail location is a confirmation of the customer request to reserve the first product.

6. A computer readable storage medium according to claim 1, wherein the customer request is a single request and includes a request to reserve a second product for pickup from a second retail location associated with a second merchant, the method further comprises
optionally verifying an available inventory of the second product at the second retail location electronically;
generating a message to the second retail location for physical inventory verification of the second product at the second retail location; and
receiving a message from the second retail location with physical inventory information for the second product at the second retail location;
wherein generating a message to the client device includes generating the message to include reservation information for the second product at the second retail location if the physical inventory information indicates that the second product is present at the second retail location.

7. A computer readable storage medium according to claim 6, wherein:
generating the message to the first retail location comprises generating the message to the first retail location using a first message protocol; and
generating the message to the second retail location comprises generating the message to the second retail location using a second message protocol.

8. A computer readable storage medium according to claim 7, wherein:
generating the message to the client device comprises generating the message to the client device using a third message protocol.

9. A computer readable storage medium according to claim 7, wherein:
receiving a message from the first retail location comprises receiving the message from the first retail location through a web service.

10. A method, comprising:
providing an electronic database including product information associated with a plurality of merchants, each merchant having one or more retail locations;
receiving a customer request to reserve a first product for pickup from a first retail location associated with a first merchant and a second product for pickup from a second retail location associated with a second merchant;
generating a message to the first retail location for physical inventory verification of the first product at the first retail location and a message to the second retail location for physical inventory verification of the second product at the second retail location;
receiving a message from the first retail location with physical inventory information for the first product and a message from the second retail location with physical inventory information for the second product at the second retail location; and
generating a message to the client device including reservation information for the first product at the first retail location if the physical inventory information indicates that the first product is present at the first retail location and including reservation information for the second product at the second retail location if the physical inventory information indicates that the second product is present at the second retail location.

11. A method according to claim 10, wherein:
the message to the first retail location requests physical examination of existing inventory to meet a requested quantity of the first product at the first retail location.

12. A method according to claim 11, further comprising:
electronically verifying an available inventory of the first product at the first retail location and an available inventory of the second product at the second retail location;
physically examining existing inventory at the first retail location in response to the message to the first retail location; and
generating the message from the first retail location based on physically examining the existing inventory at the first retail location.

13. A method according to claim 10, wherein:
generating the message to the first retail location comprises generating the message to the first retail location using a first message protocol; and
generating the message to the second retail location comprises generating the message to the second retail location using a second message protocol.

14. A method according to claim 13, wherein:
generating the message to the client device comprises generating the message to the client device using a third message protocol.

15. A method according to claim 13, wherein:
receiving the message from the first retail location comprises receiving the message from the first retail location using a third message protocol.

16. A method according to claim 13, wherein:
the first message protocol comprises a short messaging service message protocol; and
the second message protocol comprises an electronic mail message protocol.

17. A method according to claim 10, wherein:
the message to the first retail location includes a first identifier associated with the customer request;
the message to the second retail location includes a second identifier associated with the customer request;
receiving from the client device the first identifier and in response, generating rewards for a customer associated with the customer request; and
receiving from the client device the second identifier and in response, generating rewards for the customer associated with the customer request.

18. A method according to claim 10, wherein:
the message to the client device includes a first identifier associated with the customer request;
the method further comprises generating rewards for a customer associated with the customer request in response to receiving the first identifier from the customer or the client device.

19. A method according to claim 12, wherein:
electronically verifying an available inventory of the first product at the first retail location comprises verifying the available inventory of the first product using an application programming interface associated with the first merchant; and
electronically verifying an available inventory of the second product at the second retail location comprises verifying the available inventory of the second product using an electronic commerce website associated with the second merchant.

20. A method according to claim 19, further comprising:
receiving at least one search request associated with the electronic database prior to receiving the reservation request; and
determining from the electronic database in response to the at least one search request, product inventory information for the first product at the first retail location and product inventory information for the second product at the second retail location.

21. A method according to claim 12, wherein:
electronically verifying an available inventory of the first product at the first retail location comprises verifying the available inventory of the first product using the electronic database; and
electronically verifying an available inventory of the second product at the second retail location comprises verifying the available inventory of the second product using the electronic database.

22. A method according to claim 10, wherein:
the physical inventory information for the first product includes a human confirmation of the presence of the first product at the first retail location; and
the physical inventory information for the second product includes a human confirmation of the presence of the second product at the second retail location.

23. A method according to claim 10, wherein:
generating the message to the first retail location includes generating a first link in the message for confirming that the first product has been reserved for pickup at the first retail location; and
generating the message to the first retail location includes generating a second link in the message for denying the request to reserve the first product for pickup at the first retail location

24. A method according to claim 23, wherein:
generating the message to the first retail location includes generating a third link in the message for modifying the reservation request based on an availability of the first product at the first retail location.

25. A method according to claim 10, further comprising:
receiving at least one search request associated with the electronic database prior to receiving the reservation request; and
determining search results in response to the at least one search request based on customer information associated with the reservation request.

26. A computer-implemented method, comprising:
providing an application programming interface for a product inventory database storing product inventory information for a plurality of merchants, each merchant is associated with one or more retail locations, the product inventory information including product availability information for a plurality of products at each of the one or more retail locations of the plurality of merchants;
providing a plurality of ingest engines in communication with the product inventory database, the plurality of ingest engines including a first ingest engine configured to receive inventory information from a first merchant using a first inventory protocol and a second ingest engine configured to receive inventory information from a second merchant using a second inventory protocol;
providing a user interface to enable a single request to reserve pick-up of a first product from a first retail location associated with the first merchant and to reserve pickup of a second product from a second retail location associated with the second merchant;
providing a messaging system configured to receive in response to the single request, a first message from the first retail location with physical inventory information of the first product at the first retail location and a second message from the second retail location with physical inventory information of the second product at the second retail location; and
providing the messaging system to generate in response to the first message from the first retail location and the second message from the second retail location, one or more messages to a customer associated with the single request including instructions for pick-up of the first product if the physical inventory information of the first product indicates availability of the first product and instructions for pick-up of the second product if the physical inventory information of the second product indicates availability of the second product.

27. A computing system, comprising:
one or more computer-readable storage devices storing product inventory information for a plurality of merchants, the product inventory information associating each merchant with one or more retail locations and including product availability information for a plurality of products at each of the one or more retail locations of the plurality of merchants; and
one or more processors in communication with the one or more computer-readable storage devices, the one or more processors provide an application programming interface to the product inventory database and a plurality of ingest engines in communication with the product inventory database, the plurality of ingest engines including a first ingest engine configured to receive inventory information from a first retail location using a first inventory protocol and a second ingest engine configured to receive inventory information from a second retail location using a second inventory protocol;
the one or more processors provide a user interface to reserve pick-up of a first product from a first retail location associated with a first merchant and to reserve pickup of a second product from a second retail location associated with a second merchant;
the one or more processors provide a messaging system configured to receive in response to the single request, a first message from the first retail location with physical inventory information of the first product at the first retail location and a second message from the second retail location with physical inventory information of the second product at the second retail location;
wherein the messaging system generates in response to the first message from the first retail location and the second message from the second retail location, a third message to a customer associated with the single request including instructions for pick-up of the first product if the physical inventory information of the first product indicates availability of the first product and instructions for pick-up of the second product if the physical inventory information of the second product indicates availability of the second product.

28. A customer centric electronic commerce exchange system, comprising:
one or more computer-readable storage devices storing product inventory information for a plurality of merchants, the product inventory information associating each merchant with one or more retail locations and including product availability information for a plurality of products at each of the one or more retail locations of the plurality of merchants;
the one or more computer-readable storage devices storing a customer profile for each of a plurality of customers, each customer profile including a plurality of customer preferences including at least one of a service provider preference, a communication protocol preference, a brand preference, and a payment method preference;
one or more processors programmed to mediate communication between the plurality of merchants and the plurality of customers using an interconnecting bus with protocol translations that interface with a plurality of disparate communication systems provided by the plurality of merchants;
the one or more processors are programmed to provide a user interface for receiving reservation requests from the plurality of customers for pickup of a plurality of N products across a plurality of M retail locations in a single user interface session, wherein in response to a first reservation request from a first customer for reservation of a first plurality of products from a first plurality of retail locations, the one or more processors generate a physical inventory verification message to each retail location associated with the first reservation request and generate one or more notifications to the first customer with confirmation of the reservation request at the plurality of retail locations.

29. A customer centric electronic commerce exchange system according to claim 28, wherein:
in response to the first reservation request, the one or more processors access a customer profile associated with the first customer to determine a communication protocol preference of the first customer; and
the one or more processors generate the one or more notifications to the first customer using the communication protocol preference of the first customer.

30. A customer centric electronic exchange system according to claim 29, wherein:
the one or more computer-readable storage devices store a merchant profile including a communication protocol preference for each retail location associated with a merchant; and
the one or more processors generate the physical inventory verification message to each retail location associated with the first reservation request based on the communication protocol preference from the merchant profile associated with each retail location.

31. A customer centric electronic exchange system according to claim 30, wherein:
the one or more processors receive a customer request for product information and availability from the plurality of merchants; and
the one or more processors access a customer profile associated with the customer request and filter the product inventory information according to the customer profile associated with the customer request.

32. A customer centric electronic exchange system according to claim 31, wherein:
in response to the first reservation request from the first customer, the one or more processors access the customer profile associated with the first customer to determine at least one of the payment method preference and the service provider preference.

33. A customer centric electronic exchange system according to claim 28, wherein:
each customer profile is generated based on past shopping behavior of a corresponding customer.

34. A customer centric electronic exchange system according to claim 33, wherein:
each customer profile is supplemented based on the past shopping behavior of the corresponding customer.
